(19) United States
(12) Patent Application Publication
(10) Pub. No.: US 2017/0242955 A1
(43) Pub. Date: Aug. 24, 2017

(54) METHOD OF MANUFACTURING SEMICONDUCTOR DEVICE

(71) Applicant: Renesas Electronics Corporation, Tokyo (JP)

(72) Inventors: Yoshihiro ONO, Tokyo (JP); Kenji SAKATA, Tokyo (JP)

(21) Appl. No.: 15/403,203

(22) Filed: Jan. 11, 2017

(30) Foreign Application Priority Data
Feb. 19, 2016 (JP) 2016-029652

(51) Int. Cl. G06F 17/50

(52) U.S. Cl. CPC G06F 17/5081; G06F 17/5072; G06F 2217/12

(57) ABSTRACT

A method includes: a first step of designing the semiconductor device by using CAD and outputting design CAD data; a second step of correcting the design CAD data to correspond to a matching trial object of the semiconductor device and outputting corrected CAD data; a third step of manufacturing the semiconductor device based on the design CAD data; a fourth step of capturing a tomographic image of the manufactured semiconductor device; a fifth step of comparing a shape and a dimension of a unit included in the semiconductor device between the tomographic image and the corrected CAD data; and a sixth step of determining that the matching trial object is failed when a difference therebetween as a result of the comparison in the fifth step is equal to or larger than a predetermined amount.

### CROSS-REFERENCE TO RELATED APPLICATION

The present application claims priority from Japanese Patent Application No. 2016-029652 filed on Feb. 19, 2016, the content of which is hereby incorporated by reference into this application.

### TECHNICAL FIELD OF THE INVENTION

The present invention relates to a technique of manufacturing a semiconductor device. More particularly, the present invention relates to a technique effectively applied to a method of manufacturing a semiconductor device for inspecting a matching trial object of a manufactured semiconductor device.

### BACKGROUND OF THE INVENTION

When it is necessary to observe a cross-sectional shape for an internal structure and electrical connection of a semiconductor device in inspection and analysis of a matching trial object of the manufactured semiconductor device, it is general to employ such a method of polishing the semiconductor device as exposing the cross section. However, in the method using the polishing, for example, when the shape analysis is performed over a plurality of cross sections in a depth direction, it is necessary to perform the analysis while polishing the device little by little, and therefore, it takes time and cost for the analysis. In addition, since the method is destructive inspection, the method has such a problem that a polished unit cannot be observed again.

As a method for solving the problem, for example, a non-destructive three-dimensional inspection method that employs an X-ray computed tomography (CT) and others is used. A tomographic image captured by the X-ray CT can be handled as image data by using a computer, and thus, the matching trial object can be analyzed by, for example, comparing the tomographic image and computer-aided design (CAD) data based on a calculation on the computer.

As a technique relating to the above-described method, for example, Japanese Patent No. 4082718 (Patent Document 1) and Japanese Patent No. 5220316 (Patent Document 2) describe a technique of inspecting a defect of a target object by comparing the CAD data and the image data obtained by the tomography apparatus such as the X-ray CT.

### SUMMARY OF THE INVENTION

Various heat treatments and heat processes are performed during a process of manufacturing a semiconductor device, and, as a result, a practical matching trial object is different from the design CAD data at a certain degree in some cases such that deformation such as warpage or distortion occurs or such that a solder alloy portion that is not on the design occurs. In such a case, the appropriate determination of the matching trial object is impossible in some cases in employing the shape analysis method of comparing the design CAD data and the tomographic image obtained by the X-ray CT as a conventional technique.

This is because the design CAD data is data created at the time of design before the manufacture, and because a determination criteria for the matching trial object after the manufacture is not reflected on the design CAD data. Particularly in inspection for a three-dimensional shape dimension, a contour shape of the matching trial object can be variously changed from the design CAD data, and therefore, the appropriate shape analysis is impossible even by the comparison with the design CAD data different from the matching trial object.

Other object and novel characteristics will be apparent from the description of the present specification and the accompanying drawings.

A method of manufacturing a semiconductor device according to an embodiment includes: a first step of designing the semiconductor device by using CAD to output design CAD data; a second step of correcting the design CAD data so as to correspond to a matching trial object of the semiconductor device and outputting corrected CAD data; a third step of manufacturing the semiconductor device based on the design CAD data; a fourth step of capturing a tomographic image of the manufactured semiconductor device; a fifth step of comparing the tomographic image and the corrected CAD data in a shape and a dimension of a unit included in the semiconductor device; and a sixth step of determining that the matching trial object is failed when a difference therebetween as a result of the comparison in the fifth step is equal to or larger than a predetermined amount.

According to the embodiment, an accuracy of in the shape analysis can be improved by comparing the tomographic image of the semiconductor device obtained using X-ray CT and the CAD data of the semiconductor device.

### BRIEF DESCRIPTIONS OF THE DRAWINGS

FIG. 1 is a flowchart illustrating an overview regarding an example of a flow of a process of a method of manufacturing a semiconductor device including a matching trial object analysis according to an embodiment;

FIG. 2 is a flowchart illustrating an overview regarding an example of flow of a success-or-failure determination process according to the embodiment;

FIG. 3 is a diagram illustrating an overview regarding an example in which corrected CAD data is obtained by FEM analysis according to the embodiment;

FIGS. 4A and 4B are diagrams illustrating an overview regarding each example of a material parameter and a standard adaptation range in the FEM analysis according to the embodiment;

FIG. 5 is a diagram illustrating an overview regarding examples of combination conditions of a plurality of material parameter values according to the embodiment;

FIG. 6 is a diagram illustrating an overview regarding an example of a technique of extracting a contour shape of an inspection target object according to the embodiment;

FIG. 7 is a diagram illustrating an overview regarding an example of alignment between a tomographic image and corrected CAD data according to the embodiment;

FIG. 8 is a diagram illustrating an overview regarding an example of linkage in a unit element between the tomographic image and the corrected CAD data according to the embodiment;

FIGS. 9A and 9B are diagrams illustrating an overview regarding an example of a matching trial object analysis according to the embodiment;

FIG. 10 is a diagram illustrating an overview regarding an example of estimation of a cause of failure according to the embodiment;

FIGS. 11A and 11B are diagrams illustrating an overview regarding a configuration example of the semiconductor device;

FIG. 12 is a diagram illustrating an overview regarding a configuration example of the semiconductor device;

FIG. 13 is a flowchart illustrating an overview regarding an example of a flow of a conventional process of a method of manufacturing a semiconductor device including a matching trial object analysis of the related art;

FIG. 14 is a diagram illustrating an overview regarding an example of design CAD data; and

FIG. 15 is a diagram illustrating an example of a cross-sectional shape in a matching trial object of a solder bump.

### DESCRIPTIONS OF THE PREFERRED EMBODIMENTS

Hereinafter, embodiments of the present invention will be described in detail based on the accompanying drawings. Note that the same components are denoted by the same reference symbols throughout all the drawings for describing the embodiments in principle, and the repetitive description thereof will be omitted. On the other hand, while the part described with the reference character in a certain diagram is not illustrated again in the description for other drawings, the part is described with the same reference character in some cases.

To a method of manufacturing a semiconductor device according to an embodiment of the present invention, a non-destructive three-dimensional inspection method which compares CAD data and a tomographic image captured using X-ray CT is applied in a matching trial object analysis of the manufactured semiconductor device. Accordingly, a plurality of optional cross sections of the semiconductor device can be repeatedly inspected for a short period of time. Further, the accuracy of the shape analysis is improved by using not the design CAD data different from the matching trial object but the corrected CAD data which has been subjected to such correction as corresponding to the matching trial object as the CAD data. Further, the cause of the failure can be estimated based on an inspection result, and a result of the estimation can be fed back for correction of a manufacturing condition.

Note that the semiconductor manufacturing method according to the present embodiment can be applied to a semiconductor manufacturing apparatus or a semiconductor inspection apparatus such as an X-ray CT apparatus as a system by, for example, executing a program using a central processing unit (CPU) or using control and calculation through hardware such as a microcomputer.

Alternatively, the method can be configured as a system which associates a computer system executing the program and performing control and calculation as described above with the semiconductor manufacturing apparatus, the X-ray CT apparatus, or others.

<Semiconductor Device>

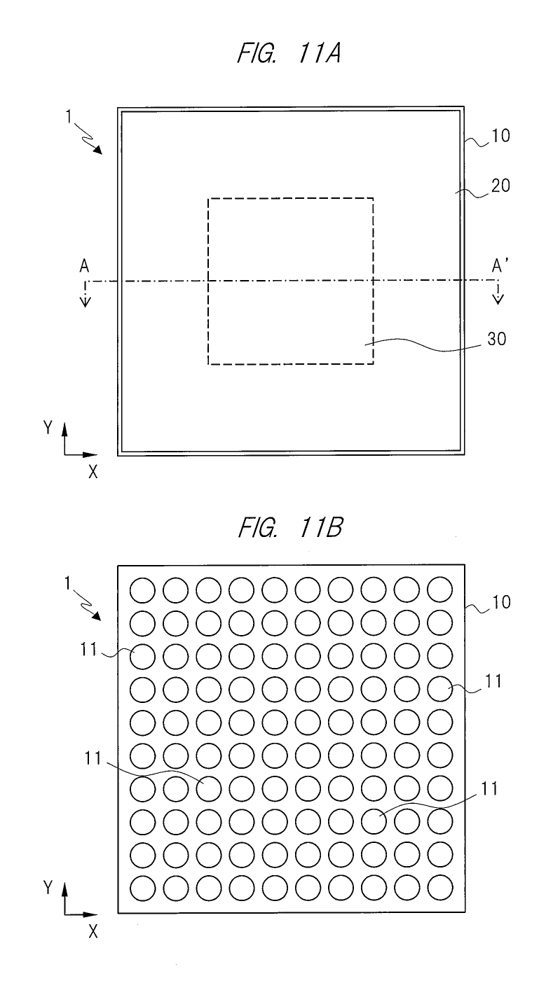

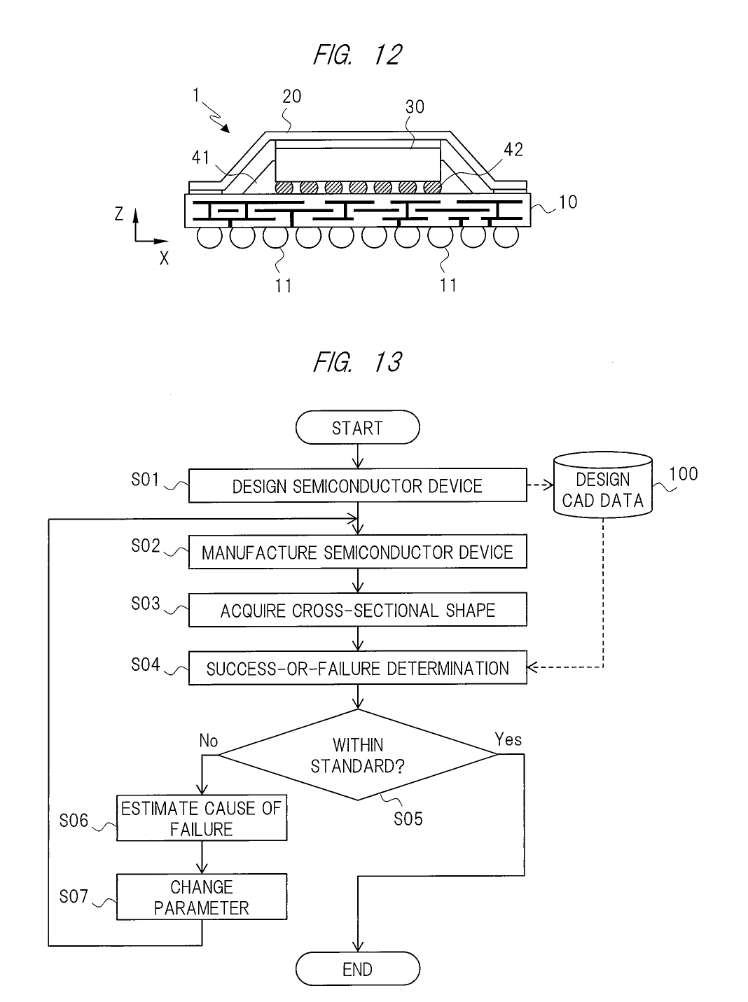

FIGS. 11A to 12 are diagrams illustrating an overview regarding a configuration example of the semiconductor device. In the present embodiment, a flip chip ball grid array (FCBGA) package is exemplified as a semiconductor device 1 which is an object to be measured and inspected. FIGS. 11A and 11B illustrate respective examples of a top view and a bottom view of the package, and further, an example of a side view of a cross section A-A′ in FIG. 11A is illustrated in FIG. 12. Note that the semiconductor device 1 is not limited to the FCBGA, and may be another type of a semiconductor device, or may be an electronic device or apparatus or others including them.

In the top view in FIG. 11A, the semiconductor device 1 includes a semiconductor chip (die) 30 which is mounted on an organic substrate 10 and a lid 20 which covers the semiconductor chip. Alternatively, the semiconductor device may not include the lid 20. When the semiconductor device includes the lid 20, the semiconductor chip 30 cannot be directly viewed from above. However, in FIG. 11A, a position of the semiconductor chip 30 is illustrated using a dotted line for convenience. In addition, in the bottom view in FIG. 11B, the semiconductor device 1 includes a plurality of solder balls 11 each of which is arranged to correspond to each electrode of the organic substrate 10. In the examples of FIGS. 11A and 11B, note that FIG. 11A is illustrated as the top view and FIG. 11B is illustrated as the bottom view. However, the top and the bottom may be reversely handled.

The side view in FIG. 12 shows that the semiconductor chip 30 mounted on the organic substrate 10 is electrically connected to the organic substrate 10 via a solder bump 42. Further, the solder bump 42 is sealed by an underfill resin 41.

<Conventional Method of Manufacturing Semiconductor Device and Conventional Technique of Matching Trial Object Analysis>

FIG. 13 is a flowchart illustrating an overview regarding an example of a processing flow of a method of manufacturing a semiconductor device including a conventional matching trial object analysis. First, the semiconductor device 1 is designed using CAD (S01). Although details of content of the design process is not particularly described, for example, here, the output design CAD data 100 is recorded and accumulated as a database so that the data can be referred and searched.

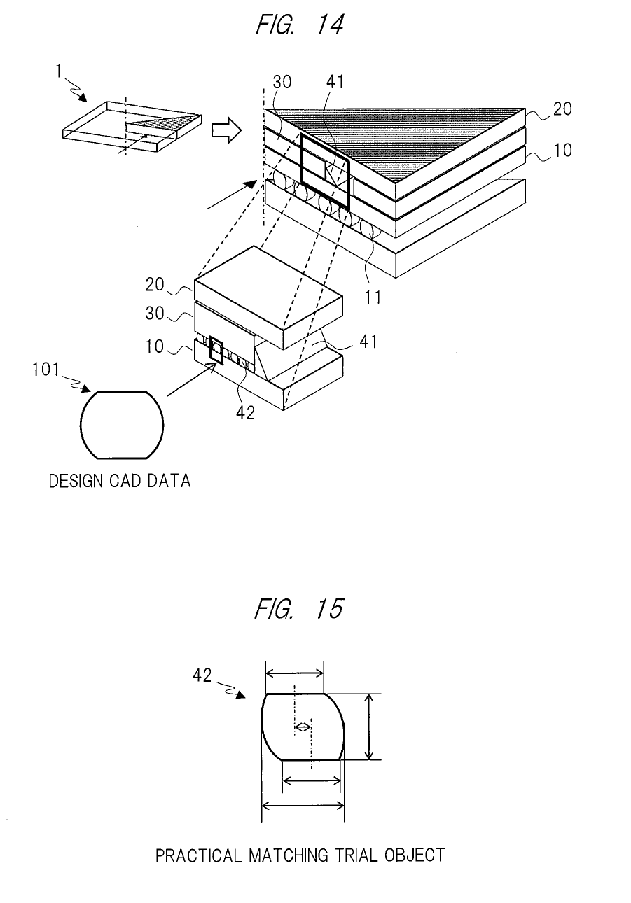

FIG. 14 is a diagram illustrating an overview regarding an example of the design CAD data 100. Here, each example of a layer structure and a cross-sectional shape of the semiconductor device 1 designed using the CAD is illustrated in a perspective view. Particularly, the solder bump 42 which becomes an inspection target for the matching trial object in the present embodiment is exemplified, and the cross-sectional shape of the example is illustrated as design CAD data 101. As illustrated, the cross-sectional shape of the solder bump 42 in the design CAD data 101 is such a shape as cutting top and bottom of a circle to be flat so as to be almost symmetrical without distortion. Note that the cross-sectional shape of the solder bump 42 is two-dimensionally illustrated here. However, in a practical design CAD data 101, each unit including the solder bump 42 is illustrated as three-dimensional voxel data.

Returning to FIG. 13, next, the semiconductor device 1 is manufactured (S02) based on the design content in Step S01. Although details of content of the manufacturing process are not particularly described, either, steps for various types of heat treatment and heat process such as a reflow process for soldering and a baking process for drying are included in each manufacturing process. In the manufacturing process in Step S02, note that a product of a shipment target may be manufactured or a prototype or a product for test may be manufactured.

Then, the matching trial object analysis is performed for the semiconductor device 1 manufactured in Step S02. First, a cross-sectional shape of the manufactured semiconductor device 1 at a desired position is acquired (S03). As described above, a destructive inspection technique of obtaining a cross-sectional shape by polishing the semiconductor device 1 has been conventionally applied. Meanwhile, as described in Patent Documents land 2 or others, non-destructive inspection using X-ray CT is performed in some cases.

FIG. 15 is a diagram illustrating an example of the cross-sectional shape of a matching trial object of the solder bump 42. As described above, various types of heat treatment and heat process are performed in the process of manufacturing the semiconductor device 1. Linear expansion coefficients of the units (for example, the organic substrate 10, the lid 20, the semiconductor chip 30, and others) of the semiconductor device 1 are different from one another. Accordingly, when the heated semiconductor device 1 is cooled, change in dimension such as a warpage and a distortion occurs in the semiconductor device 1 or each of the units of the semiconductor device 1 since degrees of expansion or contraction of the unit are different from one another. As a result, as illustrated in FIG. 15, the cross-sectional shape of the matching trial object of the solder bump 42 of the manufactured semiconductor device 1 is distorted in comparison with that of the design CAD data 101 illustrated in FIG. 14 so that top and bottom of the shape are misaligned in right and left directions.

Returning to FIG. 13, then, a success-or-failure determination is performed (S04) by comparing the design CAD data 100 obtained in Step S01 (the design CAD data 101 of the solder bump 42 in the present embodiment) and the matching trial object of the inspection target object obtained in Step S03 (the solder bump 42 in the present embodiment). For example, each dimension of the cross-sectional shape in the matching trial object of the solder bump 42 as illustrated in FIG. 15 is practically measured, and it is determined whether or not the dimension is within a standard (within a range defined by an upper limit and a lower limit) based on the design CAD data 101 as illustrated in FIG. 14 (S05). When the dimension is within the standard, it is determined that the device has been suitably manufactured, and the process ends.

On the other hand, when the dimension is not within the standard, while the cause of the failure is estimated by human's decision based on a status of the determination and others (S06), and various parameters such as a material parameter of the manufacturing condition are appropriately changed based on the content of estimation (S07), and then, the process returns to Step S02 to manufacture the semiconductor device 1 again. That is, for the matching trial object of the semiconductor device 1, a series of processes are repeated until the dimension of the cross-sectional shape of the inspection target unit enters within the standard.

In the above-described conventional manufacturing method and inspection method, while one of the target and the reference to be compared is the cross-sectional shape of the practical matching trial object having a shape distortion or others, the other is the ideal design CAD data 100 having no shape distortion. Accordingly, it is difficult to appropriately perform contrast and comparison between them, and it is difficult to improve the accuracy of the matching trial object analysis.

<Method of Manufacturing Semiconductor Device and Matching Trial Object Analysis Technique>

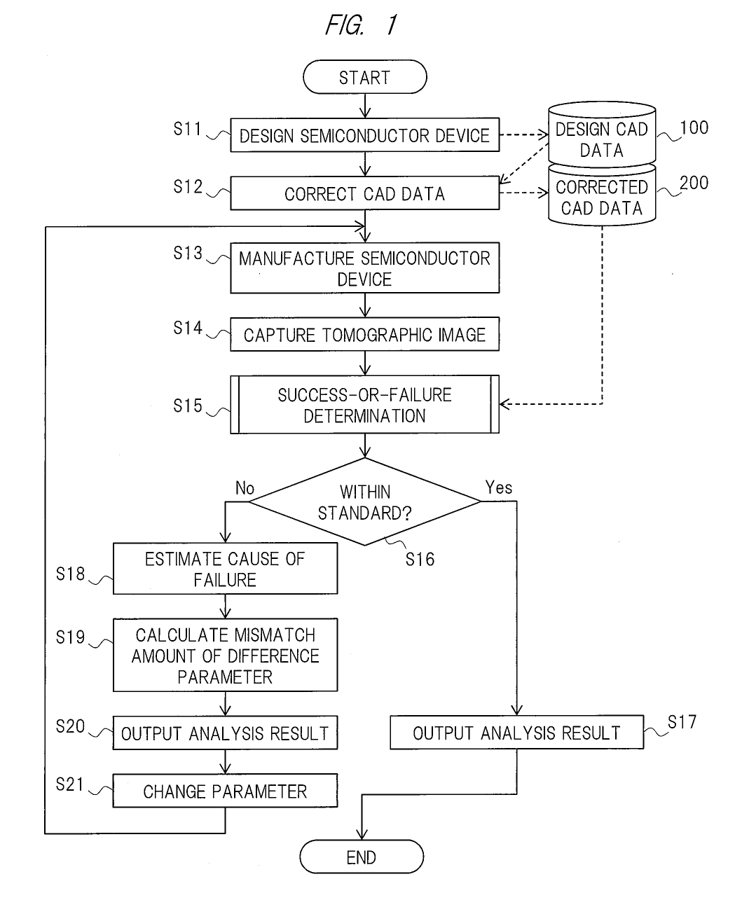

FIG. 1 is a flowchart illustrating an overview regarding an example of a processing flow of a method of manufacturing a semiconductor device including a matching trial object analysis according to one embodiment of the present invention. First, as similar to Step S01 of the conventional technique illustrated in FIG. 13, the semiconductor device 1 is designed using CAD (S11). Details of content of the design process will not be described because the details are not particularly limited. Meanwhile, the output design CAD data 100 is recorded and accumulated here so that the data can be referred and searched.

Next, in the present embodiment, the design CAD data 100 is corrected so that a status of the matching trial object is reflected to the data (S12). As the specific correction content, for example, correction of a contour shape and a dimension value of a unit or others and addition of a unit may be cited. Hereinafter, such content of correction will be described.

(1) Correction of Contour Shape and Dimension Value

This step corrects a certain difference in the shape dimension between the design CAD data 100 and the matching trial object caused by the change in dimension due to thermal history such as reflow and baking during the process of manufacturing the semiconductor device 1 and due to the warpage and the distortion because of mismatch of material characteristics among the respective units. To be specific, the corrected CAD data 200 is obtained by acquiring the shape dimension of the matching trial object to be obtained by the manufacturing process and correcting the design CAD data 100 based on the acquired shape dimension.

In order to acquire the shape dimension of the matching trial object, for example, a result of finite element method (FEM) analysis can be used, or dimensions of the respective units of the practically-manufactured semiconductor device 1 can be practically measured. The process of obtaining the corrected CAD data 200 by reflecting the shape dimension of the matching trial object acquired here to the design CAD data 100 and obtaining may be manually performed by a human. Alternatively, the process may be automatically performed through computer processing or others if possible.

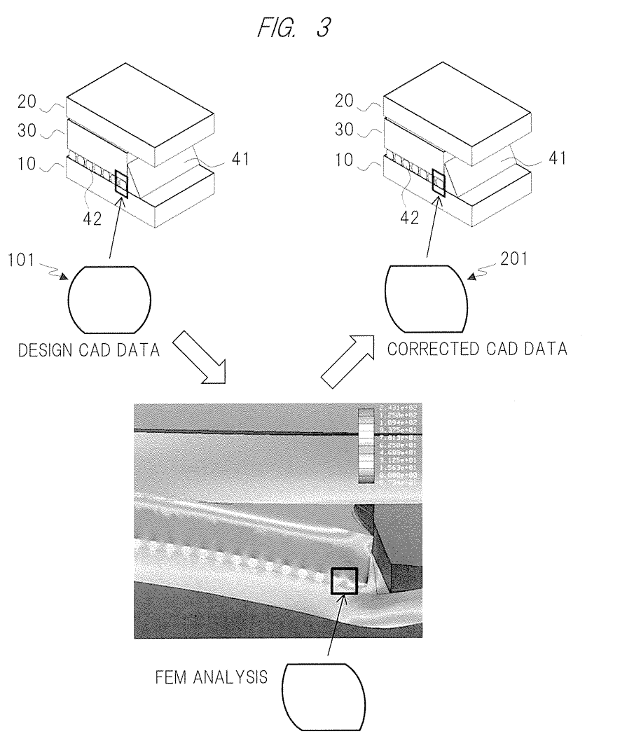

FIG. 3 is a diagram illustrating an overview regarding an example in which the corrected CAD data 200 is obtained using the FEM analysis. The drawing on the upper left side illustrates the design CAD data 101 in relation to the solder bump 42 as similar to the drawing illustrated in FIG. 14. On the other hand, the drawing on the lower side illustrates an example of a stress analysis result obtained by calculation of a computer such as the three-dimensional FEM analysis. The corrected CAD data 200 (the corrected CAD data 201 in relation to the solder bump 42 in the example of the drawing) is generated as illustrated in the drawing on the upper right side by inputting a result of the FEM analysis to correct the design CAD data 100 (the design CAD data 101 in the example of FIG. 3). Note that a publicly-known technique can be appropriately used as a specific technique of correcting the CAD data based on the result of the FEM analysis.

In the correction using the FEM analysis as described above, it is desirable to analyze each material parameter of the units forming the semiconductor device 1 for each condition of combinations in appropriate value change and to store a result of the analysis so that the result can be referred. As the material parameter that can influence the shape dimension of the matching trial object, it is possible to appropriately use, for example, a parameter relating to assembly accuracy (such as accuracy of alignment between the semiconductor chip 30 and the organic substrate 10), a parameter relating to a dimension of a material (such as a thickness of a core material of the organic substrate 10 (substrate core material)), a parameter relating to a property of the material (such as a linear expansion coefficient of the substrate core material or an underfill resin 41), and others.

A shape dimension value, which is obtained as a result of FEM analysis with a combination in a case of usage of a design value (reference value) for each material parameter, corresponds to that of the matching trial object of the semiconductor device 1 manufactured using the design value (reference value) for the each material parameter. In addition, a range or a region is referred to as a standard adaptation range, the range or the region including a result of FEM analysis with combination of values set within a range between standard upper and lower limits of each material parameter.

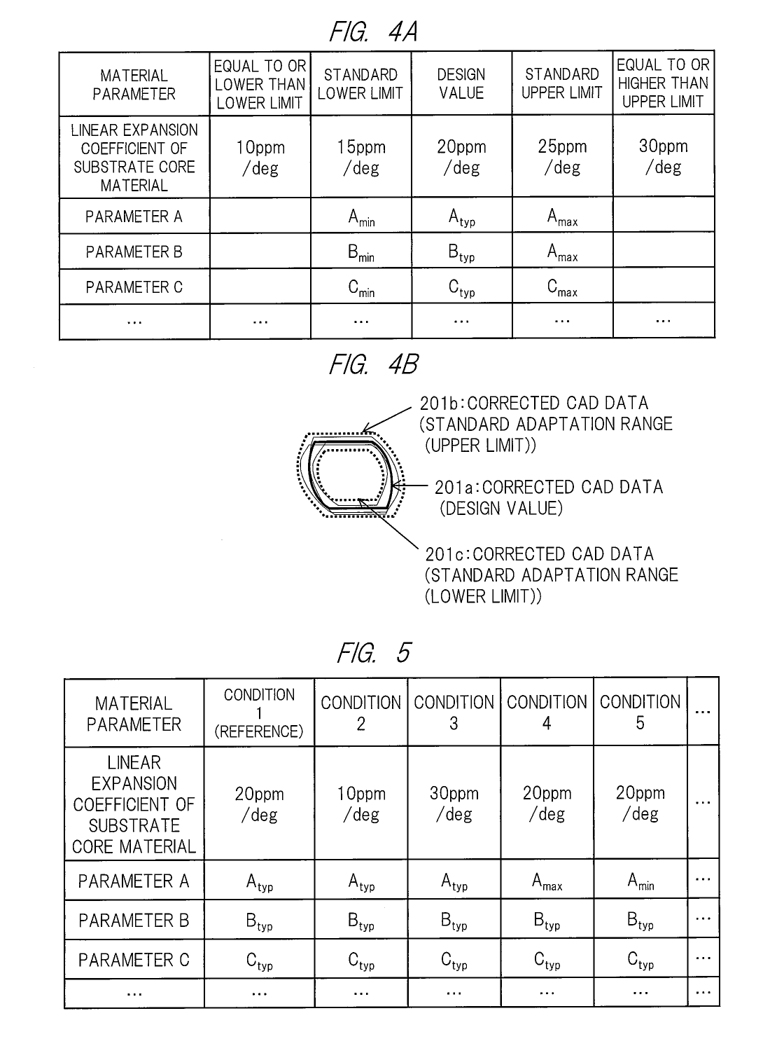

FIGS. 4A and 4B are diagrams illustrating an overview regarding each example of the material parameter and the standard adaptation range in the FEM analysis. FIG. 4A illustrates an example of setting content of the design value (reference value), the standard upper and lower limit values, and besides, a representative value equal to or higher than the standard upper limit and a representative value equal to or lower than the standard lower limit if necessary, which are set for each of various material parameters. For example, linear expansion coefficient values of the substrate core material are shown so as to be set as the design value=20 ppm/deg, the standard lower limit=15 ppm/deg, the standard upper limit=25 ppm/deg, and besides, the representative value which is equal to or lower than the standard lower limit=10 ppm/deg, and the representative value which is equal to or higher than the standard upper limit=30 ppm/deg.

FIG. 4B illustrates examples of the design value, and the upper and lower limits of the standard adaptation range of the corrected CAD data 200 which have been obtained by the FEM analysis while changing each material parameter value. This drawing illustrates each example of the corrected CAD data 201a with the design value (reference value) in relation to the solder bump 42, and the corrected CAD data 201b and 201c with the upper and lower limits of the standard adaptation range. An FEM analysis result, which is obtained using the design value for all material parameters, correspond to the corrected CAD data 201a. In addition, a region obtained by overlapping FEM analysis results based on an OR condition corresponds to the corrected CAD data 201b with the upper limit of the standard adaptation range, the FEM analysis results being obtained for each combination of the standard upper and lower limits of the respective material parameters. In addition, a region obtained by overlapping them based on an AND condition corresponds to the corrected CAD data 201c with the lower limit of the standard adaptation range.

Note that the respective FEM analysis results obtained while changing the respective material parameter values in order to obtain the corrected CAD data 200 can be used as comparison data in the determination of the quality of the matching trial object of the practically-manufactured semiconductor device 1. Accordingly, it is desirable to record and accumulate the respective FEM analysis results in linkage with information of combinations of the respective material parameter values at the time of performing the analysis.

As described above, the shape dimension of the matching trial object may be acquired by measuring a practical dimension of the practically-manufactured semiconductor device 1. For example, each dimension of the matching trial object of the solder bump 42 as illustrated in FIG. 15 is practically measured. The measurement method is not particularly limited, and, for example, an outer dimension such as a warpage shape in an outer appearance of a sample of the semiconductor device 1 may be measured, or a dimension of a cross-sectional shape or others of the solder bump 42 obtained by polishing until a desired cross section is obtained may be measured. In addition, the shape dimension of the solder bump 42 may be measured based on, for example, an image or others which is obtained using a non-destructive technique such as transmission X-ray analysis and the X-ray CT.

Further, for example, a mean value ±3σ or others may be defined as the standard upper and lower limit values by measuring practical dimensions of a plurality of samples of the semiconductor device 1 and using statistic calculation. By using these values, it is possible to create the corrected CAD data 200 with the upper limit of the standard adaptation range (the corrected CAD data 201b illustrated in FIG. 4B in the present embodiment) and the corrected CAD data 200 with the lower limit of the standard adaptation range (the corrected CAD data 201c illustrated in FIG. 4B in the present embodiment).

The design CAD data 100 is corrected based on the shape dimension of the matching trial object by using the technique as described above, so that the corrected CAD data 200 can be obtained. Meanwhile, the correction based on the FEM analysis result causes a difference between the FEM analysis result and the practical matching trial object in some cases. This is because the FEM is only an approximate calculation based on mesh division of a continuum by finite elements, and besides, because a model is simplified in some cases in order to shorten the analysis time. Thus, the matching trial object and the FEM analysis result may be matched with each other by further measuring the practical dimension of the matching trial object of the sample of the manufactured semiconductor device 1 and equalizing the practical dimension and the FEM analysis result to each other.

To be specific, for example, a primary correction is performed to the design CAD data 100 by performing the FEM analysis to the design CAD data 100 first, and then, a secondary correction (equalization) is performed based on the result obtained by measuring the practical dimension. Note that equalization with the FEM analysis results under combination conditions of a plurality of material parameter values is required in order to correctly equalize a change amount of each material parameter value and a change amount of a shape of the inspection target (a shape of the solder bump 42 in the present embodiment) to each other.

FIG. 5 is a diagram illustrating an overview regarding examples of the combination conditions of the plurality of material parameter values. For example, as illustrated, the FEM analysis is performed under each of a plurality of conditions which are set while partially changing the respective material parameter values from a “condition 1” in which the design value (reference value) is set for all the material parameters. Then, to each analysis result, the practical dimension of the sample of the semiconductor device 1 which is practically manufactured so as to correspond to each corresponding condition is equalized. Accordingly, the accuracy of the corrected CAD data 200 can be improved.

As described above, the correction of the design CAD data 100 may be performed by adding a new unit not embedded in the original design CAD data 100 in addition to the above-described correction of the contour shape or the dimension value. For example, in the manufacturing process, a solder alloy layer is formed between an electrode and a solder in some cases when the solder bump 42 is connected by the reflow to the electrode which is formed on a surface of the organic substrate 10 and which is made of copper or nickel. The solder alloy layer formed here is handled as the new unit, and added to the corrected CAD data 200. In this case, a user manually corrects the design CAD data 100 based on, for example, a result obtained by practically observing and measuring the matching trial object such as the cross section.

Returning to FIG. 1, then, the semiconductor device 1 is manufactured (S13) based on the design content in Step S11 as similar to Step S02 of the conventional technique illustrated in FIG. 13. In the example of FIG. 1, the correction of the design CAD data 100 in Step S12 and the manufacture in Step S13 are sequentially performed in series. However, they may be performed in parallel. That is, it is only required here to perform Step S12 of obtaining the corrected CAD data 200 from the design CAD data 100 by no later than the practical manufacture of the semiconductor device 1 and the matching trial object analysis of the semiconductor device.

After the semiconductor device 1 is manufactured, the matching trial object analysis of the semiconductor device is performed. First, a tomographic image of the manufactured semiconductor device 1 is captured through the non-destructive inspection by using the X-ray CT (S14). In the X-ray CT, a plurality of sliced tomographic images of the semiconductor device 1 can be obtained. By performing image processing and reconstruction to the obtained respective tomographic image, three-dimensional internal information (voxel data) of the semiconductor device 1 can be obtained. Then, a success-or-failure determination process is performed (S15) by comparing the corrected CAD data 200 (the corrected CAD data 201 in relation to the solder bump 42 in the present embodiment) obtained in Step S12 with the three-dimensional tomographic image information of the inspection target object (the solder bump 42 in the present embodiment) obtained in Step S14.

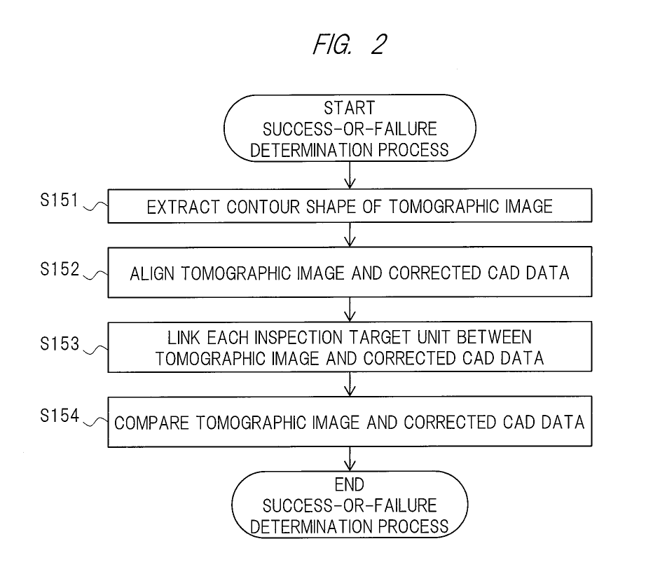

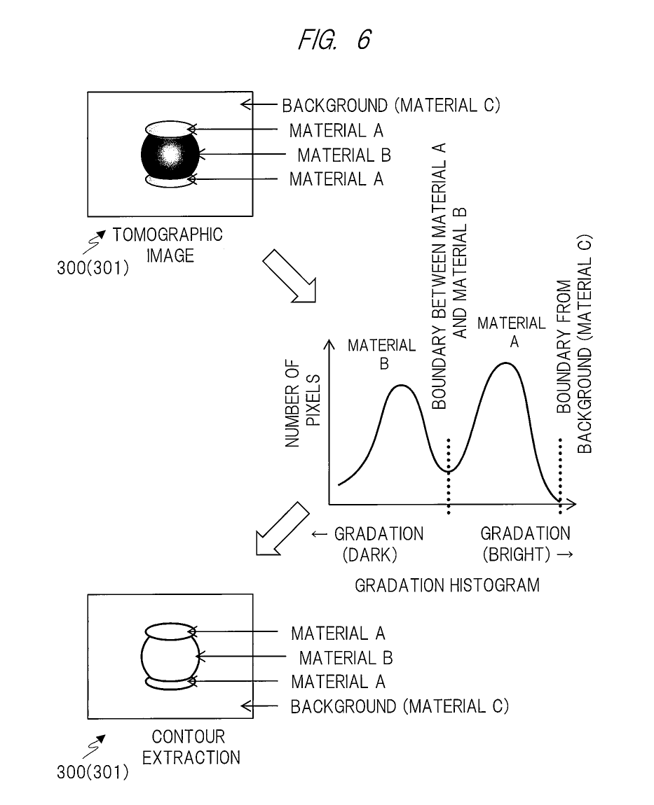

FIG. 2 is a flowchart illustrating an overview regarding an example of flow of the success-or-failure determination process. When the success-or-failure determination process is started, first, the contour shape of the inspection target object of the tomographic image is extracted by performing the image processing (S151). FIG. 6 is a diagram illustrating an overview regarding an example of a technique of extracting the contour shape of the inspection target object. The drawing on the upper side schematically illustrates an example of a tomographic image 300 (the tomographic image 301 in relation to the solder bump 42 in the drawing), obtained using the X-ray CT onto the vicinity of the inspection target object (the solder bump 42 in the present embodiment). In the drawing, a ball-shaped material B is the solder, and a material A on upper and lower sides thereof is the electrode made of copper or others. The other unit is a background region made of a material C.

For extracting the contour of the target object from such image data, a publicly-known technique such as a histogram method can be appropriately used. In the histogram method, a threshold of gradation for separating different units is acquired by obtaining a gradation histogram of the image data (each three-dimensional voxel data). The middle of FIG. 6 illustrates an example of the histogram, and shows that a gradation level at which the number of pixels is minimized is set as a boundary between the units as illustrated. Further, by extracting a voxel at the gradation level of the boundary (or the vicinity of the boundary) in the tomographic image 300, the tomographic image 300 (the tomographic image 301 in relation to the solder bump 42 in the drawing) which is formed by extracting the contour shape of each unit can be obtained as illustrated in the drawing on the lower side.

Returning to FIG. 2, next, the tomographic image 300 formed by extracting the contour shape in Step S151 and the corrected CAD data 200 are aligned with each other in the success-or-failure determination process (S152). FIG. 7 is a diagram illustrating an overview regarding an example of the alignment between the tomographic image 300 and the corrected CAD data 200. In the present embodiment, regarding the entire semiconductor device 1, the tomographic image 300 formed by extracting the contour shape (the drawing on the lower left side) is aligned based on the corrected CAD data 200 (the drawing on the upper left side). To be specific, centers of gravity of the semiconductor device 1 between them are matched with each other (the drawing on the upper right side). At this time, both the tomographic image 300 and the corrected CAD data 200 are expressed as the voxel data and have the same scale as each other, and thus, processes such as magnification, reduction and rotation are not performed (not required). Note that each center of gravity can be automatically calculated from the voxel data.

Returning to FIG. 2, in the success-or-failure determination process, next, the respective unit elements included in the tomographic image 300 and the corrected CAD data 200 aligned with each other in Step S152 are linked with each other (S153). Accordingly, for each of the units in the tomographic image 300 formed by extracting the contour shape, unit information (such as the shape dimension and the material information) of the corresponding unit in the corrected CAD data 200 can be referred and compared. To be specific, the linkage is performed by specifying the unit having a contour shape similar to that of the unit of the tomographic image 300 formed by extracting the contour shape from the corrected CAD data 200.

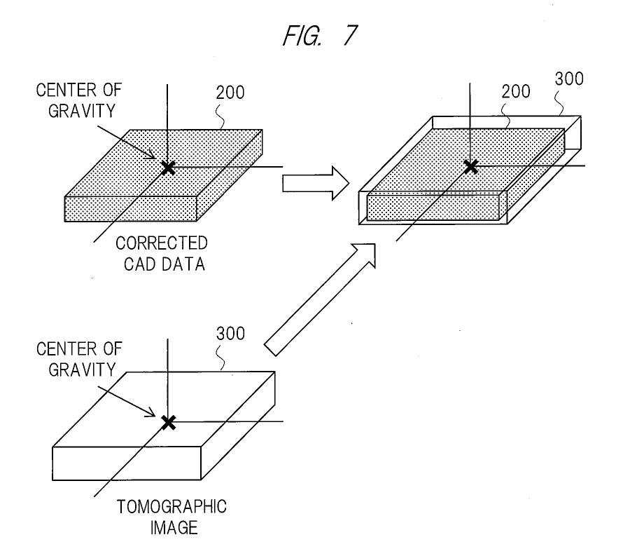

FIG. 8 is a diagram illustrating an overview regarding an example of the linkage in the unit element between the tomographic image 300 and the corrected CAD data 200. The drawing on the left illustrates a status in the vicinity of the inspection target unit (the solder bump 42 in the example of FIG. 8) in a state in which the tomographic image 300 and the corrected CAD data 200 have been aligned to each other in the entire semiconductor device 1. In the alignment at the center of gravity of the semiconductor device 1, the tomographic image 301 and the corrected CAD data 201 in relation to the solder bump 42 are shifted from each other in the center of gravity (a mark “x” in the drawing) or inclination as illustrated. In particular, the shift is larger in a peripheral unit far from the center of gravity of the semiconductor device 1. Incidentally, while the tomographic image 301 and the corrected CAD data 201 are partially overlapped with each other in the example in the left drawing, they may be not overlapped with each other at all.

In this state, first, a predetermined range of the tomographic image 300 is searched while taking the center of gravity of the corrected CAD data 201 as the center so that the unit whose center of gravity is close thereto is searched. As illustrated in the central drawing, the example of FIG. 8 shows that each unit (the solder ball and the upper and lower electrodes) inside the tomographic image 301 in relation to the solder bump 42 is searched as a candidate unit.

Next, each correlation in the contour shape between the corrected CAD data 201 and each of the searched candidate units of the tomographic image 301 is calculated, and a unit having the largest correlation, that is, having the most similar contour shape is specified. The example of FIG. 8 shows that the unit in the middle is specified as the unit having the largest correlation (the most similar contour shape) as illustrated in the right drawing. The correlation calculation of the contour shape is performed after aligning the center of gravity of the target unit of the corrected CAD data 200 and the center of gravity of the target unit of the tomographic image 300. For example, the correlation can be obtained by calculating a ratio of the number of voxels included in a region overlapping with the target unit of the tomographic image 300 to the total number of voxels included in the contour of the target unit of the corrected CAD data 200.

The linking process among the unit elements between the tomographic image 300 and the corrected CAD data 200 as described above may be automatically performed through computer processing or may be manually performed while a user checks a monitor. The unit elements may be liked to one another for each of all units included in the semiconductor device 1 or appropriately for only some of the units.

Returning to FIG. 2, in the success-or-failure determination process, finally, the tomographic image 300 and the corrected CAD data 200 are compared with each other for each linked unit in Step S153 (S154). Accordingly, a difference between a value on the design and that of the practical matching trial object can be analyzed. In addition, it can be checked whether the quality of the matching trial object is within the standard adaptation range as illustrated in the example of FIGS. 4A and 4B or not.

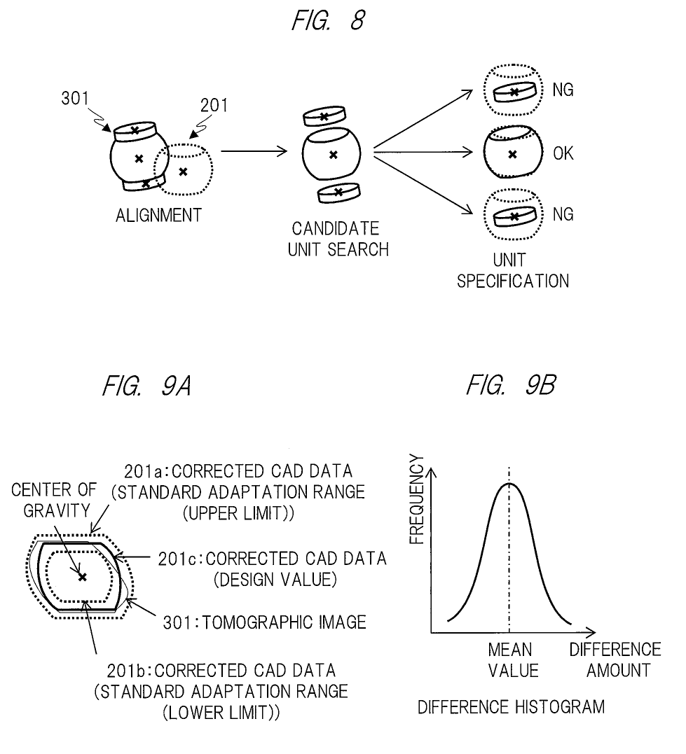

FIGS. 9A and 9B are diagrams illustrating an overview regarding an example of the matching trial object analysis. FIG. 9A illustrates a state in which the centers of gravity of the tomographic image 301 and the corrected CAD data 201 are aligned to each other and are compared with each other in relation to the solder bump 42. The corrected CAD data 201 shows that the corrected CAD data 201c with the design value and the corrected CAD data 201a and 201b with the upper and lower limits of the standard adaptation range. Although FIG. 9A is two-dimensionally illustrated for convenience, the comparison is practically in the three-dimensional voxel data.

As a content for the comparison in the alignment, for example, a positional shift amount is calculated by acquiring a difference (movement amount in the alignment of the center of gravity) at the center of gravity between the tomographic image 301 and the corrected CAD data 201, acquiring a rotation angle of the contour shape, or acquiring others. At this time, for example, the correlation calculation result of the contour shape of the target unit that has been described in FIG. 8 can be used. In addition, the number of voxels in a region where the tomographic image 301 and the corrected CAD data 201c (with the design value) are not overlapped with each other is calculated, so that the difference in the shape therebetween may be found.

In addition, the number of voxels in a region where the contour of the tomographic image 301 is out of the corrected CAD data 201a (with the upper limit of the standard adaptation range) (a region where the shape dimension of the target unit is larger than the standard adaptation range) is calculated, and then, it may be determined that the dimension is within the standard adaptation range when the number of voxels is zero. In addition or alternatively, the number of voxels in a region where the contour of the corrected CAD data 201b (with the lower limit of the standard adaptation range) is out of the tomographic image 301 (a region where the shape dimension of the target unit is smaller than the standard adaptation range) is calculated, and then, it may be determined that the dimension is within the standard adaptation range when the number of voxels is zero.

In addition, a histogram illustrated in FIG. 9B may be created by acquiring the tomographic image 300 by the X-ray CT capturing for a plurality of samples of the semiconductor device 1 and acquiring a difference of each inspection target unit from the corrected CAD data 200. Accordingly, the distribution of matching trial objects in a manufacturing lot which includes the inspection target semiconductor device 1 can be found and output.

Returning to FIG. 1, and the success-or-failure determination process as described above is performed (S15). As a result, for each inspection target unit, it is determined whether the shape dimension of the matching trial object is within the standard adaptation range or not (S16). If it is within the standard, it is determined that the semiconductor device has been appropriately manufactured, and then, for example, the result and content of the success-or-failure determination process in Step S15 are output to the user such as being displayed on the monitor (S17), and the process is terminated.

On the other hand, if it is without the standard, that is, if it is found that there is the difference between the matching trial object of the inspection target unit and the design value, the cause of the failure is estimated based on the content of the difference and others (S18), and then, a mismatch amount of the material parameter is calculated (S19).

To be specific, the analysis result having the similar contour shape is searched and specified by comparing the tomographic image 300 and a plurality of FEM analysis results obtained while changing the condition of the material parameter value at the time of correcting the design CAD data 100 in Step S12. Further, the content of the condition of the material parameter value corresponding to the specified FEM analysis result is compared with that of the material parameter value (that is, the design value) of the manufacturing condition at the time of practically manufacturing the semiconductor device 1 including the inspection target unit in Step S13. Accordingly, the material parameter which becomes the cause making the difference between the matching trial object and the design value (more correctly, the corrected CAD data 200 obtained by correcting the design CAD data 100) is estimated, and the mismatch amount therebetween is calculated.

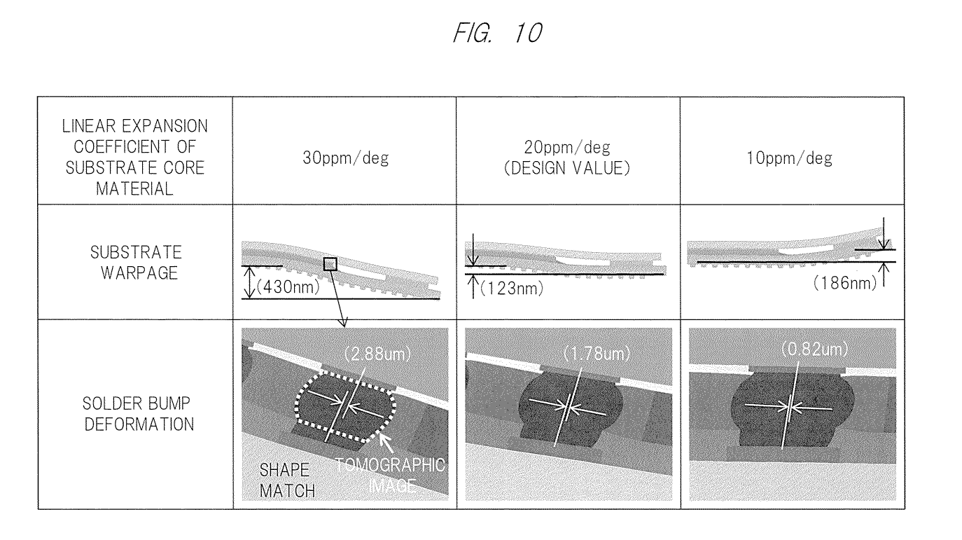

FIG. 10 is a diagram illustrating an overview regarding an example of estimation of the cause of the failure. FIG. 10 illustrates the example obtained while changing the linear expansion coefficient of the core material (substrate core material) of the organic substrate 10 which is one of the units of the semiconductor device 1 is changed as the material parameter. To be specific, for each linear expansion coefficient, the drawing illustrates each result of a warpage amount of the organic substrate 10 and a deformation amount of the solder bump 42 (both of them are shown by using parentheses in the drawing) obtained by the FEM analysis. As illustrated, it is understood that the larger the linear expansion coefficient of the substrate core material is, the larger both of the warpage amount of the organic substrate 10 and the deformation amount of the solder bump 42 are.

Further, the the example of FIG. 10 shows that the FEM analysis result obtained when the linear expansion coefficient of the substrate core material is 30 ppm/deg is the most similar to the contour shape of the practical tomographic image 301 of the solder bump 42. For the determination on the similarity of the contour shape, the technique such as the above-described correlation calculation described in FIG. 8 can be appropriately employed.

In this case, it can be estimated that the matching trial object of the linear expansion coefficient of the substrate core material used in the semiconductor device 1 which becomes the target for acquisition of the tomographic image 301 is 30 ppm/deg higher than 20 ppm/deg which is the design value. That is, it can be estimated that the material parameter which is the cause of the difference between the design value and the matching trial object in the solder bump 42 is the linear expansion coefficient of the substrate core material of the organic substrate 10, and that the mismatch amount from the design value is “30-20=10 ppm/deg”.

The example of FIG. 10 shows the case in which only the linear expansion coefficient of the substrate core material is changed as the material parameter. However, if the FEM analysis is performed while changing other material parameters, the success or failure of the matching trial object of a matching trial object regarding other material parameters can be determined. In addition, if the FEM calculation is performed for each condition obtained by combining a plurality of material parameters (for example, the linear expansion coefficient of the substrate core material and the linear expansion coefficient of the underfill resin 41, or others), the success or failure of the matching trial object can be determined for each combination.

Further, in the example of FIG. 10, the target to be compared between the tomographic image 300 and the FEM analysis result is set as the deformation amount of the solder bump 42. However, it is obvious that other unit is set as the comparison target. In addition, for example, a plurality of comparison target items also including comparison of the warpage amount of the organic substrate 10 in addition to the deformation amount of the solder bump 42 may be set. Accordingly, the success-or-failure determination of the matching trial object can be more accurately performed.

Returning to FIG. 1, the material parameter which becomes the cause of the failure in the matching trial object of the semiconductor device 1 is estimated, and the mismatch amount thereof is calculated in Steps S18 and S19, and then, the result and content of the parameter and the mismatch amount are output to the user so as to be displayed on the monitor (S20). For example, the tomographic image 300 of the matching trial object is displayed on the monitor, and a portion having the difference in the contour shape because of the mismatch of the material parameter is highlighted by changing a color or others. The content of the material parameter which becomes the cause of the difference and the information of the mismatch amount may be displayed. Accordingly, the user can easily visually find the portion having the matching failed object and the cause of the failure.

Then, the material parameter value in the manufacturing condition is changed and corrected (S21) so as to reflect the material parameter which is the cause of the difference and the mismatch amount output in Step S20 thereon, and the semiconductor device 1 is manufactured again returning to Step S13. For example, as illustrated in the example of FIG. 10, when the material parameter which is the cause of the difference is the linear expansion coefficient of the substrate core material, and besides, when the mismatch amount is 10 ppm/deg, the semiconductor device 1 is manufactured again using a substrate core material which is formed by correcting (reducing) the linear expansion coefficient of the substrate core material in the target manufacturing lot by 10 ppm/deg.

Further, a series of processes of Step S13 and the subsequent steps are repeated until the shape dimension of the matching trial object of the semiconductor device 1 enters within the standard adaptation range.

As described above, in the method of manufacturing the semiconductor device according to the embodiment of the present invention, the tomographic image 300 captured using the X-ray CT and the corrected CAD data 200 corrected based on the result of the matching trial object are compared with each other in the matching trial object analysis of the manufactured semiconductor device 1. Accordingly, the accuracy of the shape analysis can be improved, the mismatch amount from the material parameter which is the cause of the failure can be estimated based on the inspection result, and the result can be fed back to the correction of the manufacturing condition. In addition, by employing the non-destructive technique of using the tomographic image 300 captured using the X-ray CT, a plurality of arbitrary cross sections of the semiconductor device 1 can be repeatedly inspected for a short period of time. In the foregoing, the invention made by the present inventors has been concretely described based on the embodiments. However, it is needless to say that the present invention is not limited to the foregoing embodiments and various modifications and alterations can be made within the scope of the present invention. For example, the above-described embodiments have been explained for easily understanding the present invention, but are not always limited to the one including all structures explained above. Further, the other structure can be added to/eliminated from/replaced with a part of the structure of the above-described embodiments.

For example, in the present embodiment, the X-ray CT is used in order to obtain the tomographic image of the semiconductor device 1. However, other non-destructive tomographic imaging technique can be also appropriately used. In addition, the FEM is used as the technique of acquiring the matching trial object through numerical calculation. However, other numerical calculation or simulation technique can be also appropriately used.

The present invention can be employed for a method of manufacturing a semiconductor device for inspecting a matching trial object of the manufactured semiconductor device.

What is claimed is:

1. A method of manufacturing a semiconductor device which includes inspection of a matching trial object of the semiconductor device, the method comprising:
a first step of designing the semiconductor device by using CAD and outputting design CAD data;
a second step of correcting the design CAD data so as to correspond to the matching trial object of the semiconductor device and outputting corrected CAD data;
a third step of manufacturing the semiconductor device based on the design CAD data;
a fourth step of capturing a tomographic image of the manufactured semiconductor device;
a fifth step of comparing the tomographic image and the corrected CAD data in a shape and a dimension of a unit included in the semiconductor device; and
a sixth step of determining that the matching trial object is failed when a difference therebetween as a result of the comparison in the fifth step is equal to or larger than a predetermined amount.

2. The method of manufacturing the semiconductor device according to claim 1,
wherein the correction of the design CAD data in the second step includes correction of the dimension of the unit included in the semiconductor device.

3. The method of manufacturing the semiconductor device according to claim 1,
wherein the correction of the design CAD data in the second step includes addition of a unit which is newly formed in manufacturing the semiconductor device.

4. The method of manufacturing the semiconductor device according to claim 2,
wherein a dimension of the unit of the design CAD data is corrected based on an output which is acquired by numerical calculation of the matching trial object of the semiconductor device.

5. The method of manufacturing the semiconductor device according to claim 2,
wherein a dimension of the unit of the design CAD data is corrected based on a dimension which is practically measured in the semiconductor device which is practically manufactured.

6. The method of manufacturing the semiconductor device according to claim 2,
wherein a dimension of the unit of the design CAD data is corrected based on an output which is acquired by numerical calculation of the matching trial object of the semiconductor device and based on a dimension which is practically measured in the semiconductor device which is practically manufactured.

7. The method of manufacturing the semiconductor device according to claim 1,
wherein, in the second step, an upper limit and a lower limit of an adaptation range of a shape and a dimension of the unit of the corrected CAD data are further determined based on an output which is acquired by numerical calculation of the matching trial object of the semiconductor device for each condition of combination of a design value, an upper limit value, and a lower limit value of one or more material parameters in a manufacturing condition of the semiconductor device.

8. The method of manufacturing the semiconductor device according to claim 7,
wherein, in the fifth step, the tomographic image is compared with the upper limit and the lower limit of the adaptation range of the corrected CAD data for the unit, and,
in the sixth step, it is determined that the matching trial object is failed when the tomographic image exceeds the upper limit or the lower limit of the adaptation range.

9. The method of manufacturing the semiconductor device according to claim 1,
wherein the correction of the design CAD data in the second step includes correction of a shape and a dimension of the unit included in the semiconductor device for each condition of combination of one or more material parameter values in a manufacturing condition of the semiconductor device,
the method further includes:
a seventh step of specifying the corrected CAD data having the most similar shape and dimension of the unit to those of the tomographic image when the matching trial object is failed in the fifth step; and
an eighth step of acquiring each difference between a design value of each of the material parameters at time of manufacturing the semiconductor device which is an inspection target and a value of each of the material parameters corresponding to the corrected CAD data specified in the seventh step, and specifying the material parameter which is a cause of the failure and an amount of the corresponding difference.

10. The method of manufacturing the semiconductor device according to claim 9, further comprising
a ninth step of changing the manufacturing condition of the semiconductor device based on the amount of the difference corresponding to the material parameter specified in the eighth step.

11. The method of manufacturing the semiconductor device according to claim 10,
wherein the third and subsequent steps are repeated based on the manufacturing condition changed in the ninth step until it is not determined that the matching trial object is failed in the sixth step.
